(19) United States
(12) Patent Application Publication
(10) Pub. No.: US 2006/0179130 A1
(43) Pub. Date: Aug. 10, 2006

(54) Control entity for a communication network having a number of network elements

(75) Inventor: Joachim Charzinski, Munchen (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: Siemens Aktiengesellschaft

(21) Appl. No.: 11/347,547

(22) Filed: Feb. 3, 2006

(30) Foreign Application Priority Data
Feb. 4, 2005 (DE) 102005005279.7

(51) Int. Cl. G06F 15/177

(52) U.S. Cl. 709/220

(57) ABSTRACT

A control entity for a communication network comprising a number of network elements is provided. For the purpose of configuring parameters of network elements in a communication network, the control entity features a user interface for the network operator or operator. This is designed such that changes to the parameters proposed by the control entity are proposed to the network operator and the network operator can choose between different response options to the proposed changes.

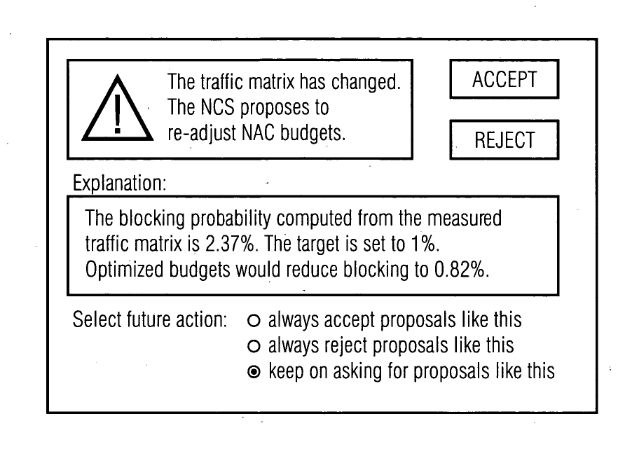

### CROSS REFERENCE TO RELATED APPLICATIONS

This application claims priority of German application No. 102005005279.7 DE filed Feb. 4, 2005, which is incorporated by reference herein in its entirety.

### FIELD OF INVENTION

The invention relates to a control entity according to the independent claims.

### BACKGROUND OF INVENTION

In a former German application from the applicant with the application file reference 102 55 922.8, a control entity or a Network Control Server (NCS) was proposed for a communication network comprising a number of network elements such as network nodes, routers, switches, bridges or gateways. This NCS allows the parameters of the network operation of the communication network to be automatically dynamically adjusted in the time domain several times per day and up to several times per hour. Nevertheless, many network operators wish to specify individual parameters of their network themselves or at least know precisely when a change is made to these parameters. Furthermore, network operators only want to use automatisms in the area of the network controller when they are convinced of their correct function. On the other hand, a control entity or a Network Control Server for a larger network can no longer be realistically tested in the system test. Operating parameters of a communication network have previously either been adjusted via the network management at the direct instigation of the operator, or they are directly configured on the network elements in the communication network by operators or via scripts.

### SUMMARY OF INVENTION

An object of the present invention is thus to improve a control entity for a communication network.

This object is achieved by a control entity with the features of the independent claims.

In accordance with the invention, a control entity or a Network Control Server is extended by a user interface for the network operator or operator. This network interface allows the operator to select different response options for a change in the parameter of the network element or the operating parameter of the communication network proposed by the Network Control Server. This is advantageous in that the critical confidence-forming phase during the introduction of an automated component, such as the Network Control Server with automatic optimization of the parameters, is positively supported in a communication network. The operator can first of all gain experience, without the risk, with the changes and/or adjustments to the parameters provided by the control entity, of the control entity bringing the communication network into an unwanted operating state. When the operator has gained more confidence in deciding on the changes proposed by the Network Control Server, he is able to automatically allow the Network Control Server to take over the parameter adjustments.

Advantageous embodiments of the invention are specified in the dependent claims.

In an advantageous embodiment of the invention, changes to the parameters proposed by the control entity are only accepted if they do not reach a first limit value. This is advantageous in that only ‘smaller’ changes to the operating parameters are accepted and larger changes require confirmation.

In another advantageous embodiment of the invention, the control entity responds to proposed changes as a function of the time of day. Thus proposed changes can for example require queries during the day and will be configured automatically over night, or vice versa. The Network Control Server is thus able to operate in a customer-friendly manner.

### BRIEF DESCRIPTION OF THE DRAWING

An exemplary embodiment of the invention is displayed in the drawing and is explained in more detail below. In this case, the figure shows a display of a user interface.

### DETAILED DESCRIPTION OF INVENTION

The figure shows a display of a user interface or a window of a Network Control Server, with two options for the response to proposed changes to the Network Control Server. On the one hand, the acceptance of the changes with the button “Accept”, as a consequence of which the changes are configured in the network and on the other hand, the rejection of the changes with the button “Reject” which rejects the changes. In addition, an explanation of the changes is shown in the window. Furthermore, a selection is shown for the procedure for future proposals of this type of the NCS. These include the options that

a) changes of this type are always accepted,

b) changes of this type are always rejected,

c) changes of this type always require a confirmation.

The control entity or the Network Control Server for configuring parameters of network elements in a communication network differs in that it comprises a user interface, like a window, for the network operator or operator, which is configured such that changes to parameters proposed by the control entity are proposed to the network operator and the network operator can choose between different response options to the proposed changes. The following response options are possible;
a) Proposed changes to the parameters are accepted and the new parameters are configured by the NCS in the network. The changes can additionally be logged in a log file.
b) Proposed changes to the parameters are accepted and the new parameters are configured in the network. A notification is additionally sent to the operator.
c) Proposed modifications to the parameters are only configured after confirmation by the network operator in the network.
d) Proposed changes to the parameters are (generally) rejected.

The control entity can respond to the proposed changes as a function of the time of day. By way of example, changes are queried during the day, and are automatically accepted during the night, or vice versa. The control entity can be designed such that an optimization of parameters can be activated or requested by the network operator and these optimized parameters can be subsequently configured in the network. The Network Control Server can feature a user interface with input facilities, which is designed such that the network operator can manually enter parameters, said parameters being evaluated and/or optimized by the NCS and said parameters and further parameters optionally being configured in the network. Furthermore, proposed changes to the parameters which do not reach a first limit value can be automatically accepted and configured in the network, and changes which exceed this or a second limit value require the confirmation by the network operator prior to configuration in the network. Thus “smaller” changes to the operating parameters can be accepted or automatically approved with confirmation only being required for larger changes. The size of the threshold value can be determined at any given level or dynamically.

Instead of the comparison of the proposed changes with a limit value, a reference value can be determined or calculated using at least some of the proposed parameters to be changed, said reference value being compared with a third limit value. The response options already described can result if this limit value is not reached or is exceeded. This reference value can be a link loading or blocking probability of at least one part of the communication network or other values or variables of the network.

This is particularly expedient if new parameters are proposed for instance for the value of the link metrics. The influence of this changing value on the behavior of the communication network can often not be directly derived from the directly proposed value, of the link metrics for instance. However, the new link loadings or blocking probability can be calculated using the proposed values for instance, said link loadings or blocking probability then being used as a reference variable or reference value for the decision regarding the installation of the proposed changes.

1.-9. (canceled)

10. A control entity for configuring a parameter of a network element in a communication network, comprising:
a user interface that displays to a user a change to the parameter proposed by the control entity; and
a plurality or response options for the proposed change,
wherein the user may choose between the plurality of response options via the user interface.

11. The control entity according to claim 10, wherein the plurality of response options are selected from the group consisting of:
accept proposed change to the parameter, configure a new parameter in the network and log to a file,
accept proposed change to the parameter, configure a new parameter in the network and transmit a notification to the operator,
configure proposed change to the parameter only after confirmation by the network operator in the network,
reject proposed change to the parameter, and
combinations thereof.

12. The control entity according to claim 11, wherein the proposed change is automatically responded to by the control entity based on a time of day.

13. The control entity according to claim 12, wherein an optimized parameter is configured in the network after a request by the user.

14. The control entity according to claim 13, wherein the user interface comprises an input facility adapted to allow the user to enter a parameter that is evaluated by the control entity.

15. The control entity according to claim 10, wherein the proposed change is automatically responded to by the control entity based on a time of day.

16. The control entity according to claim 10, wherein an optimized parameter is configured in the network after a request by the user.

17. The control entity according to claim 10, wherein the user interface comprises an input facility adapted to allow the user to enter a parameter that is evaluated by the control entity.

18. The control entity according to claim 17, wherein the entered parameter is configured in the network.

19. The control entity according to claim 18, wherein changes to the proposed parameter require confirmation by the user prior to configuration in the network when the proposed parameter exceeds a second limit value.

20. The control entity according to claim 18, wherein a reference value is determined, the determined reference value if then compared to a third limit value for changes to the proposed parameter.

21. The control entity according to claim 20, wherein the reference value is a link loading or blocking probability of the communication network.

22. The control entity according to claim 10, wherein changes to the proposed parameter require confirmation by the user prior to configuration in the network when the proposed parameter exceeds a second limit value.

23. The control entity according to claim 10, wherein a reference value is determined, the determined reference value if then compared to a third limit value for changes to the proposed parameter.

24. The control entity according to claim 20, wherein the reference value is a link loading or blocking probability of the communication network.
